(19) United States
(12) Patent Application Publication
(10) Pub. No.: US 2015/0001113 A1
(43) Pub. Date: Jan. 1, 2015

(54) Structure of Tool Holding Sheath Cross Reference To Related Application

(71) Applicant: YUN CHAN INDUSTRY CO., LTD., New Taipei City (TW)

(72) Inventors: Fu-Jui Hsiao, New Taipei City (TW); Yi-Feng Hsieh, New Taipei City (TW)

(21) Appl. No.: 14/476,723

(22) Filed: Sep. 3, 2014

Related U.S. Application Data
(63) Continuation-in-part of application No. 13/633,883, filed on Oct. 3, 2012.

(51) Int. Cl. B25H 3/04

(52) U.S. Cl. CPC B25H 3/04
USPC 206/377

(57) ABSTRACT

A tool holding sheath structure, mainly including a first accommodation body, a plurality of first accommodation spaces allowing tools to be passed through, a second accommodation body pivotally coupled to the first accommodation body through two pivoting portions, a plurality of second accommodation spaces interlaced with the first accommodation spaces, a pushing recess adapted to open the second accommodation body, and a plurality of notches adapted to accommodate partial volumes of tools. Whereby, a user can accommodate wrenches in a well-regulated manner and pivot the second accommodation body away easily to have access to tools. Furthermore, the present invention has a convenient portability while being not in use due to a simple structure and smaller volume thereof.

### CROSS REFERENCE TO RELATED APPLICATION

This application is a continuation-in-part of copending U.S. patent application Ser. No. 13/633,883 filed on Oct. 3, 2012.

### TECHNICAL FIELD OF THE INVENTION

The present invention relates to a tool holding sheath structure, and more particularly to a tool holding sheath structure not only using an interlaced accommodation design to accommodate various sizes of wrenches effectively, but having a simple structure, smaller volume and being of user-friendly access.

### DESCRIPTION OF THE PRIOR ART

In recent years, the ordinary hand tools are popularly manufactured by mass production along with the rapid progress of the technology and the production techniques. And especially, the wrench tools are popularized into the daily life of the ordinary people for the usage of DIY (Do It Yourself) and are not just the tools for the crafted technicians as before. Hence, most users do not have the concept and habit of well arranging and positioning hand tools, so that when desired to use the tools again, the tools will be found lying about within the tool box thereby making it impossible to get the desired tool rapidly and making the hand tools get lost easily. Although the owner may conveniently repurchase the lost hand tools to use, the lost hand tools have become a resource waste.

Therefore, how to solve the aforementioned problem and disadvantage are the major concern of the related companies in this area and the inventor of the present invention.

### SUMMARY OF THE INVENTION

Thus, in view of the aforementioned disadvantages, the inventor invents the present invention, a structure of a tool holding sheath with the interlaced design which can effectively hold the wrench tools having versatile specifications and sizes and can facilitate a user to take and use the wrench tools; through continuously researching, testing, and modifying the related techniques according to the abundant experience of the inventor in the art.

The main object of the present invention is to provide a tool holding sheath structure, constituted by utilizing a simple structure to achieve the easy accommodation and convenient use of wrenches.

To achieve the object mentioned above, the present invention mainly includes a first accommodation body and second accommodation body pivoted to each other through pivoting portions, one side of each of which is formed with a pushing recess, and a plurality of first accommodation spaces and a plurality of second accommodation spaces are respectively configured side by side on the first accommodation body and second accommodation body. Furthermore, a plurality of notches are aformed on one side of the second accommodation body adjacent to the first accommodation body. Whereby, the volume of the structure according to the present invention can be reduced substantially, allowing the present invention to be simple in structure, convenient in use and low in cost due to the interlaced arrangement of the first accommodation spaces and second accommodation spaces, and the pattern of allowing each notch to accommodate the partial volume of a wrench at a corresponding position when the wrenches are accepted in the first accommodation spaces and second accommodation spaces depending on the size specifications thereof.

Therefore, the present invention can solve the problems of larger volume, complicated structure, disordered accommodation way and inconvenient tool access existing in conventional tool holding sheaths to achieve the advantages mentioned above.

### BRIEF DESCRIPTION OF THE DRAWINGS

FIG. 1 is a perspective view of a preferred embodiment according to the present invention;

FIG. 2 is a top view of the embodiment according to the present invention;

FIG. 3 is a side view of the embodiment according to the present invention;

FIG. 4 is a perspective view of the embodiment according to the present invention while being viewed from another angle;

FIG. 5 is a perspective view of the embodiment according to the present invention showing the action thereof upon operation;

FIGS. 6 and 7 respectively are a perspective view of the embodiment according to the present in a use state;

FIGS. 8 and 9 respectively are a perspective view of the embodiment according to the present invention upon use; and

FIG. 10 is a schematically perspective view of another preferred embodiment according to the present invention in a use state.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention. Various changes to the described embodiments may be made in the function and arrangement of the elements described without departing from the scope of the invention as set forth in the appended claims.

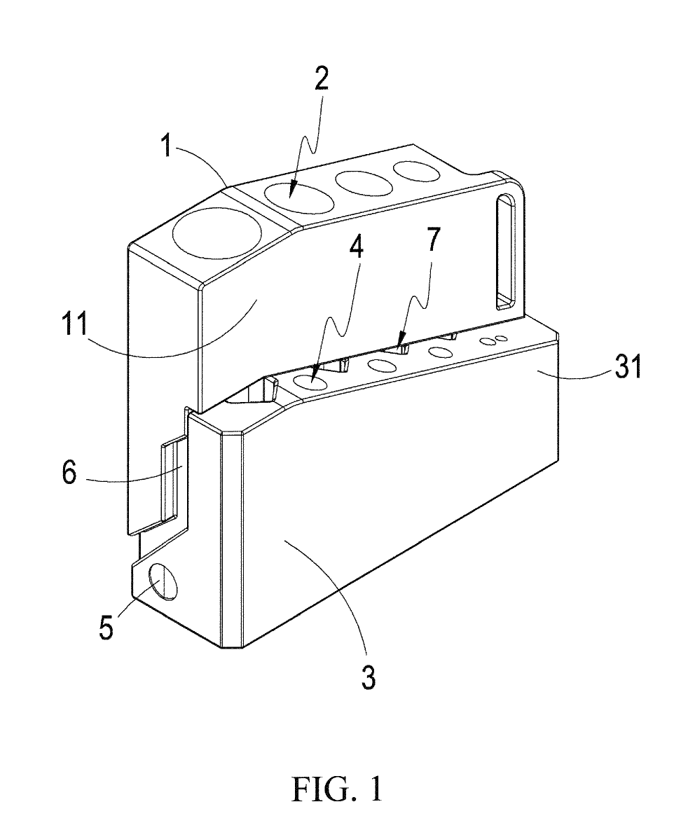

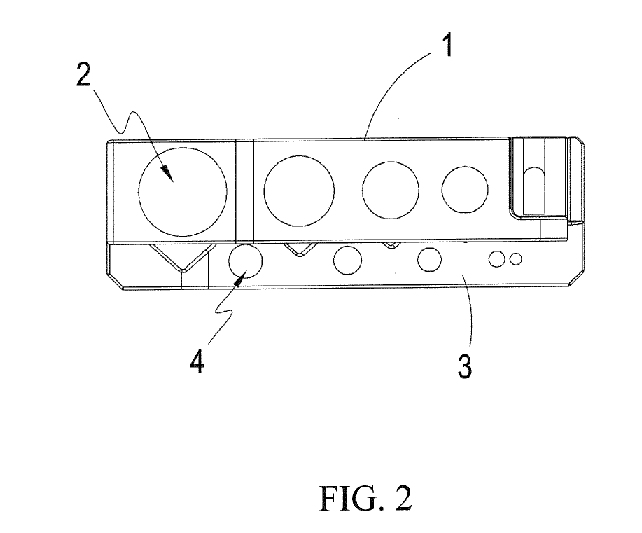

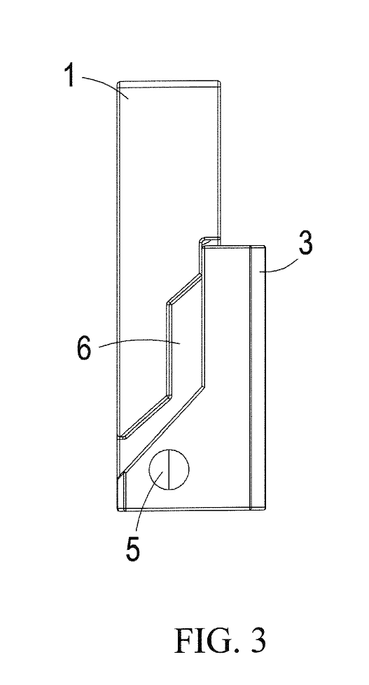

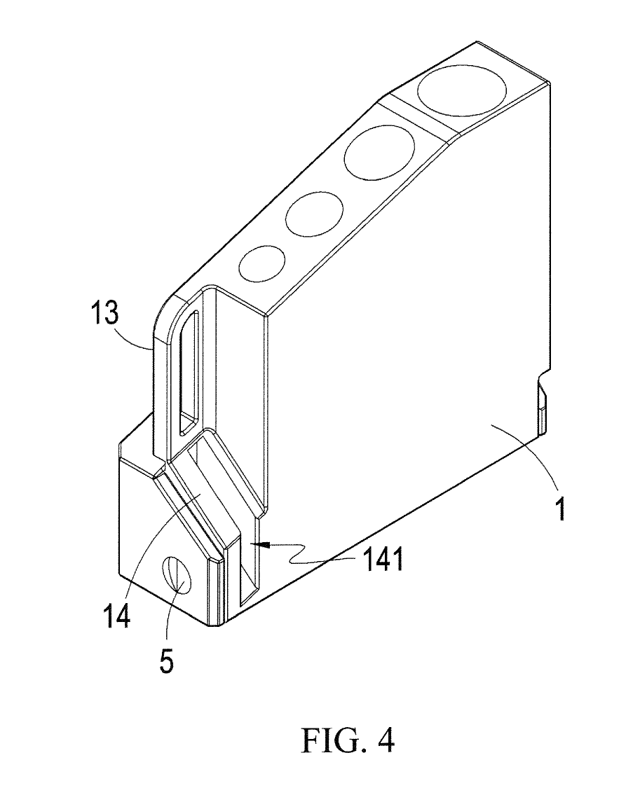

Referring to FIGS. 1 to 4, which respectively are a perspective, top view, side view and a perspective view while viewing from another angle of a preferred embodiment according to the present invention, it can be seen clearly from the figures that the present invention includes:
a first accommodation body 1, one face of which is provided with at least one first marking portion 11, one side of the first accommodation 1 being configured with a hanging-carrying portion 13, one side of the hanging-carrying portion 13 a strengthened base 14 formed by the extension from the first accommodation body 1, and the strengthened base 14 a hollow portion 141;
a plurality of first accommodation spaces 2, formed side by side on one side of the first accommodation 1 and allowing tools to be passed through and mounted thereon;
two pivoting portions 5, respectively configured on two end faces of the first accommodation body 1 in a direction of the side-by-side arrangement of the tools and away from through holes of the first accommodation spaces 2;
a second accommodation body 2, pivotally coupled to the first accommodation body 1, one face of the second accommodation 3 having at least one second marking portion 31;
a plurality of second accommodation spaces 4, formed side by side on one side of the second accommodation 3 and allowing tools to be passed through and mounted thereon, the plurality of second accommodation spaces 4 being in an interlaced arrangement with the plurality of first accommodation spaces 2;
a pushing recess, formed on the first accommodation body 1, positioned on the same side as the pivoting portion 5, and adapted to open the second accommodation body 3; and
a plurality of notches 7, formed as an indentation on one side of the second accommodation body 3 adjacent to the first accommodation body 1, and adapted to accommodate tools at corresponding positions, thereby reducing the combination volume of the first accommodation body 1 and second accommodation body 3.

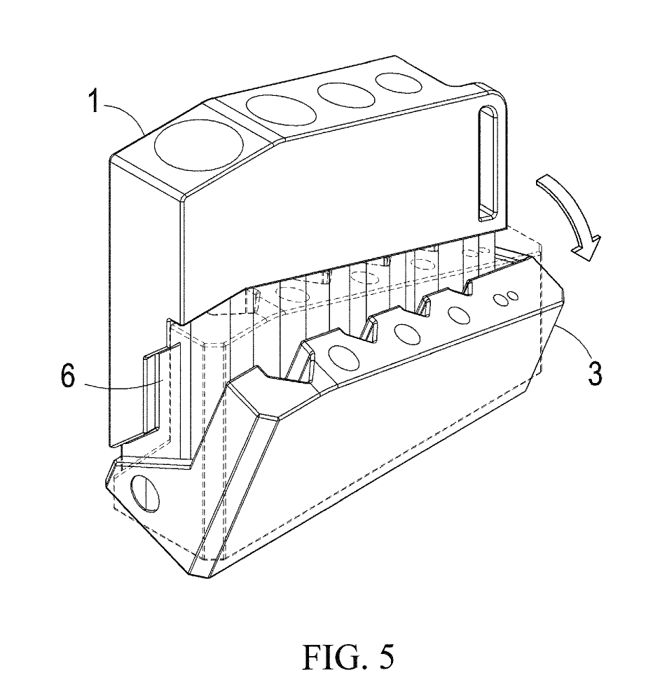

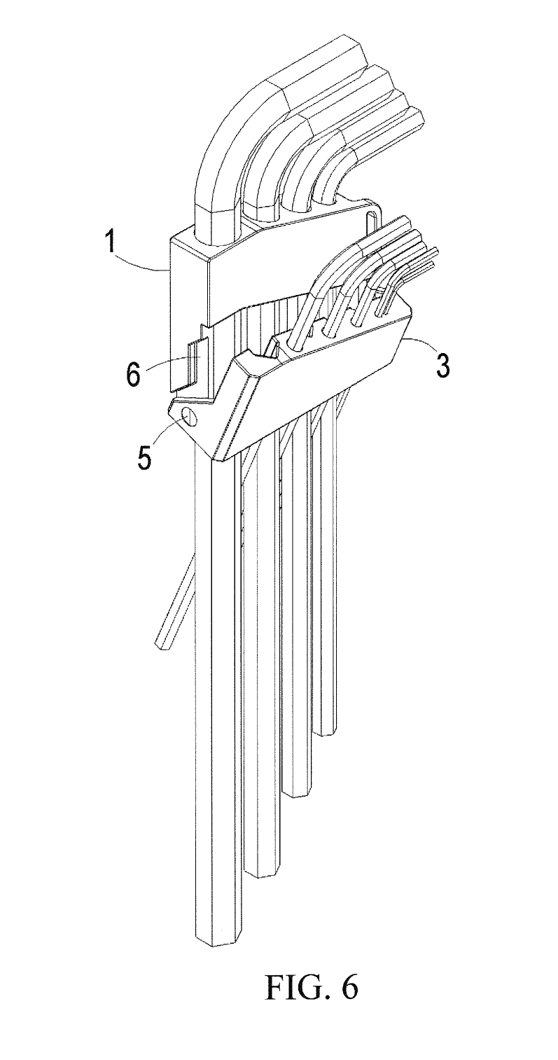

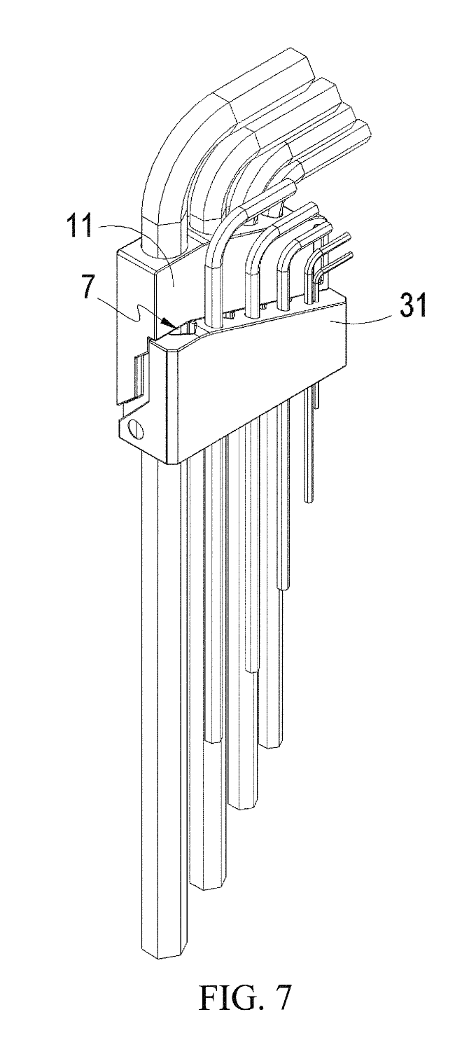

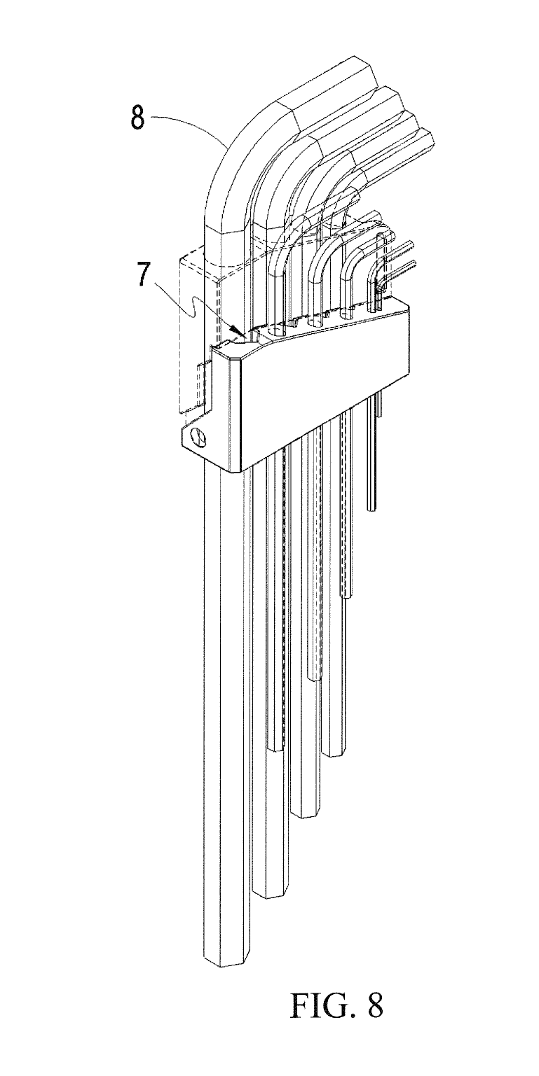

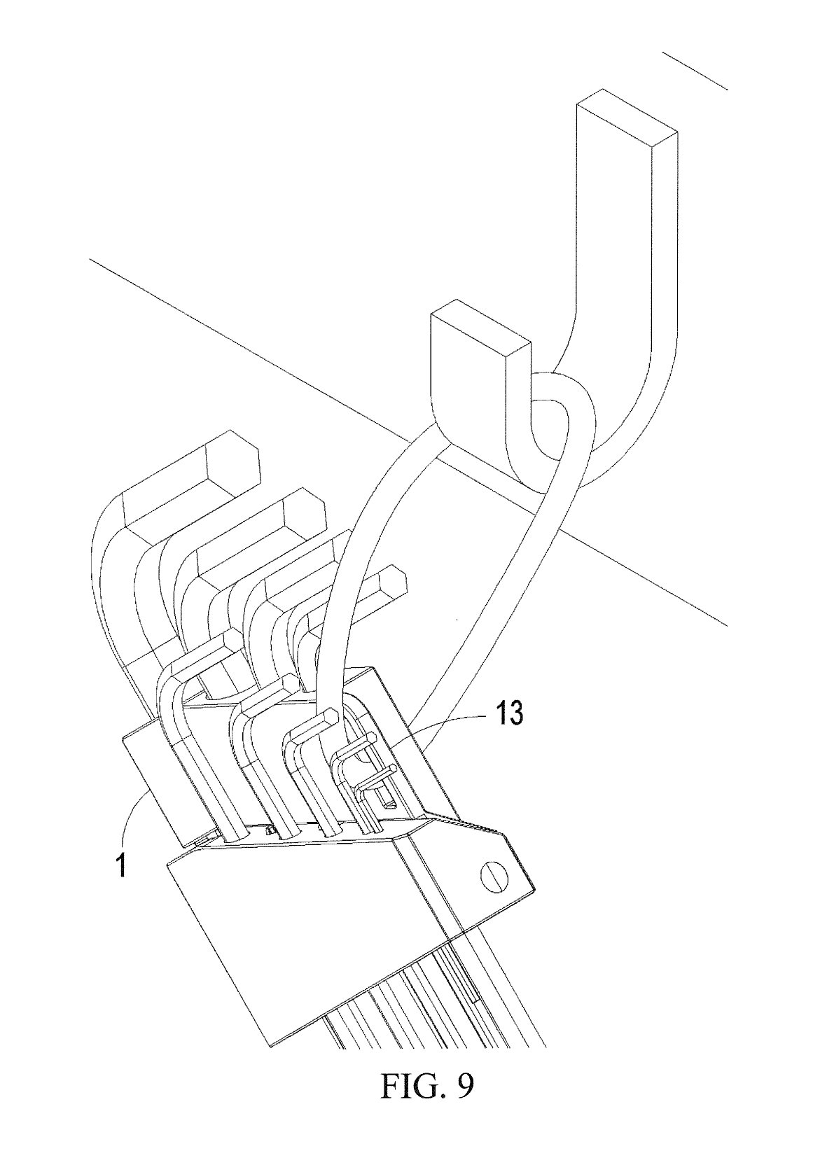

Referring to FIGS. 1 to 9 all together, which respectively are perspective view, top view, side view, perspective view while viewing from another angle, schematically perspective view for action, perspective view in a use state, another perspective view in a use state, perspective view upon use, and another perspective view upon use, it can be seen clearly from the figures that the second accommodation body 3 is pivotally coupled to the first accommodation body through the pivoting portions 5, the two end faces where the pivoting portions 5 are positioned are partially overlapped so that the first accommodation body 1 and second accommodation body 3 can be engaged fixedly with each other when the second accommodation body 3 is drawn close to the first accommodation body 1. Furthermore, the use volume of the entire structure of the present invention is allowed to be reduced substantially due to the interlaced configuration of the first accommodation spaces 2 and second accommodation spaces 4, and the accommodation of the partial volumes of tools at corresponding positions in the notches 7 so that the present invention is simple in structure and smaller in volume. Referring to FIGS. 5 and 6 again, the second accommodation body 3 can be pivoted directly outward to open only by means of the step between the pushing recess 6 and the second accommodation body 3; it is different from the fixation by means of mechanical buckling used in conventional tool holding sheaths so that the structure of the present invention is simple and the cost thereof is lower. Whereby, the tools passed through the second accommodation spaces 4 are separated from the ones passed through the first accommodation spaces 2, and an expansion pattern so induced not only does not interfere the action of a user but can use one side of each notch 7 away from the through holes to press against a tool in the corresponding first accommodation space, allowing the present invention to have a positioning function and facilitate a user having access to and alternating tools conveniently and quickly. Furthermore, the first marking portion and second marking portion are configured to facilitate a user identifying the size specifications of tools while tools are arranged side by side in sequence to pass through the first accommodation spaces 2 and second accommodation spaces 4 as FIG. 7 shows. Furthermore, the accommodation relationship between each tool and the corresponding notch 7 is shown in FIG. 8. In addition, a user may hang the tool holding sheath of the present invention together with tools on a hook besides store the tools inside a general tool box, and the strengthened base 14 extended from the first accommodation body 1 on one side of the hanging-carrying portion 13 enables the hanging-carrying portion 13 to have a sufficient strength to carry these tools. Furthermore, a hollow portion 141 is formed on the strengthened base 14, allowing the present invention not to be increased with too must material cost.

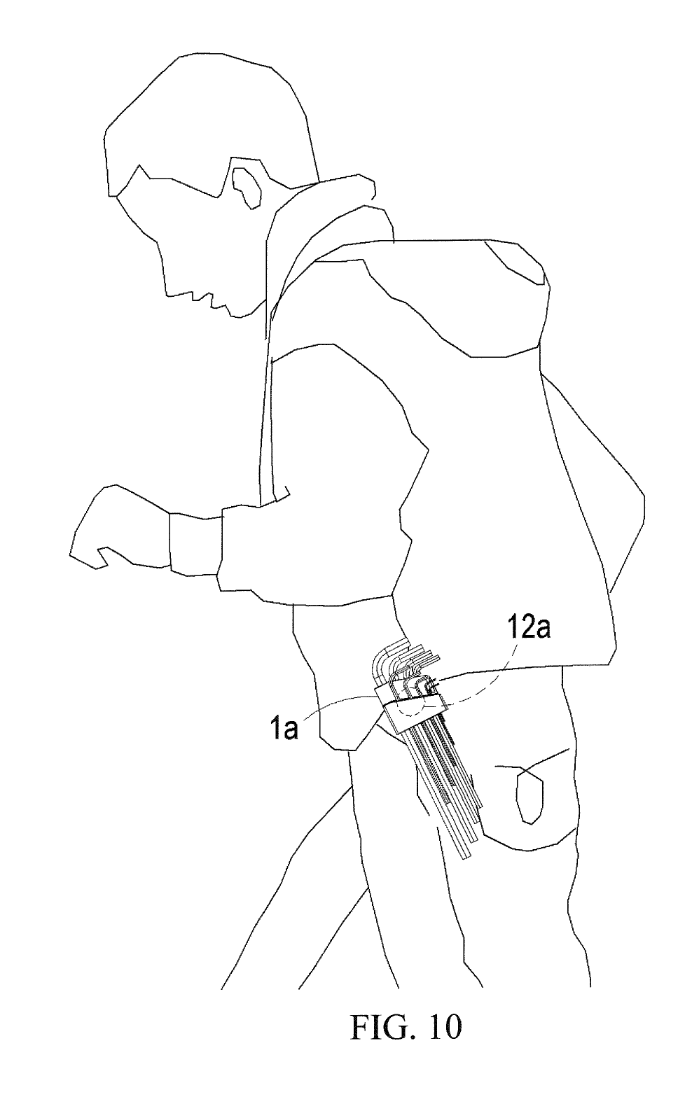

Finally, referring to FIG. 10, another face of the first accommodation body 1a is configured with a hanging-mounting portion 12a capable of being carried in the hanging way taken on by the hanging-mounting portion 12a shown in the figure.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

The structure of a tool holding sheath of the present invention has the following merits:
1. allowing a user's access to tools to be more convenient and quick due to the interlaced accommodation design, and enabling wrenches of various size specifications to be accommodated effectively.
2. achieving the advantages of tool storage with the minimum use of space and structure combination way.

I claim:

1. A tool holding sheath structure, comprising:
a first accommodation body;
a plurality of first accommodation spaces, allowing tools to be passed through and mounted thereon, formed side by side on one side of said first accommodation body;
two pivoting portions, respectively configured on said first accommodation body, positioned on two end faces in a direction of a side-by-side arrangement of said tools and away from through holes of said first accommodation spaces;
a second accommodation body, pivotally coupled to said first accommodation body through said pivoting portions;
a plurality of second accommodation spaces, allowing tools to be passed through and mounted thereon, formed side by side on one side of said second accommodation body, and said plurality of second accommodation spaces being in an interlaced arrangement with said plurality of first accommodation spaces;
a pausing recess, formed on said first accommodation body and positioned at the same side as said pivoting portion, adapted to open said second accommodation body; and
a plurality of notches, formed on one side of said accommodation body adjacent to said first accommodation body, adapted to accept tools at corresponding positions, thereby reducing a combination volume of said first accommodation body and second accommodation body.

2. The structure according to claim 1, wherein at least one marking portion is configured on one face of said first accommodation body.

3. The structure according to claim 2, wherein a hanging-mounting portion is configured on one face of said first accommodation body away from said first marking portion.

4. The structure according to claim 1, wherein at least one second marking portion is configured on one face of said second accommodation body.

5. The structure according to claim 1, wherein a hanging-carrying portion is configured on one side of said first accommodation body.

6. The structure according to claim 5, wherein a strengthened base extended from said first accommodation body is configured on one side of said hanging-carrying portion.

7. The structure according to claim 6, wherein a hollow portion is formed on said strengthened base.

8. The structure according to claim 1, wherein said two end faces positioned with said pivoting portions are overlapped partially while first accommodation body is drawn close to said second accommodation body, thereby engaging with each other fixedly.
